(19) United States
(12) Patent Application Publication
(10) Pub. No.: US 2018/0056311 A1
(43) Pub. Date: Mar. 1, 2018

(54) HEATED SPRAY SYSTEM

(71) Applicant: Spray Polyurethane Parts, Inc., Panama City, FL (US)

(72) Inventor: Keith Miller, Panama City, FL (US)

(73) Assignee: Spray Polyurethane Parts, Inc., Panama City, FL (US)

(21) Appl. No.: 15/250,420

(22) Filed: Aug. 29, 2016

(51) Int. Cl. B05B 9/00; B05B 9/04; B05B 12/00; B05B 12/10

(52) U.S. Cl. CPC B05B 9/002; B05B 12/10; B05B 12/004; B05B 9/0406

(57) ABSTRACT

A method of heating spray components with a spray proportioner unit may include flowing a spray component from a hopper through a preheater and heated hose. The spray component may be received at a receiving end of the heated hose at a first temperature and exit the heated hose at a delivery end at a second temperature. The spray component may be flowed through the heated hose at an operating pressure up to 2000 psi and at a rate up to 12 lb/minute. The second temperature may be at least 30° F., such as between 40° F. and 60° F., greater than the first temperature.

### TECHNOLOGY

The present application is directed to heated spray systems. More specifically the present application is directed to heated spray proportioner systems including mobile heated spray proportioner systems and components thereof.

### BACKGROUND

Spray proportioners are used to deliver a proportioned stream of spray components and are commonly used for spraying insulation, polyurethane foam, and polyurea formulations. Spray proportioners generally include pumps that pump individual spray components to an applicator gun via hoses. The spray components are mixed at the applicator gun and then sprayed in a combined stream. Spray proportioner pumps are typically designed to pump the various spray components through the proportioner such that the combined stream is composed of a particular proportion of each spray component. Some spray proportioners include onboard heaters that heat the spray components to a set temperature while being pumped toward a hose coupled to the applicator gun. The onboard heaters typically heat the spray components to a desired temperature of the spray components at the applicator gun. Some proportioners may also include a heated hose system for maintaining or preventing significant drops in the temperature of the heated spray components as they flow through the hose to the applicator gun.

### SUMMARY

In one aspect, a spray proportioner unit equipped may be equipped with one or more pumps to flow two spray components along separate flow paths extending between a respective hopper, through a respective preheater and heated hose, and a spray gun. A method of heating the spray components with the spray proportioner unit may include flowing the spray component from the hopper to the preheater and flowing the spray component from the preheater to the heated hose. The spray component may be received at a receiving end of the heated hose at a first temperature. The method may further include flowing the spray component from the receiving end of the heated hose to a delivery end of the heated hose at an operating pressure up to 2000 psi and at a rate up to 12 lb/minute, and heating the spray component to a second temperature with one or more heating elements extending along the heated hose as the spray component flows through the heated hose. The second temperature taken at the delivery end of the heated hose may be at least 30° F. greater than the first temperature.

In one embodiment, the second temperature is between 40° F. and 60° F. greater than the first temperature, and the first temperature is between 80° F. and 120° F. and the second temperature is between 135° F. and 160° F. The hoppers may be 5 to 7 gallon hoppers. Each heated hose may have a length of approximately 200 linear feet and an inner diameter of approximately ½ inch. Approximately 400 linear feet of approximately ⅛ inch diameter heating element may extend within the inner diameter of each heated hose. The one or more pumps, electric heaters, and heating elements may be powered at a same 220-240 VAC outlet.

In various embodiments, the second temperature is between 40° F. and 60° F. greater than the first temperature, and the first temperature is between 80° F. and 100° F. and the second temperature is between 135° F. and 160° F. The first temperature may be between 100° F. and 120° F. and the second temperature is between 135° F. and 160° F.

In one embodiment, the heating elements extend within an inner diameter of the heated hoses and define a portion of the flow path through each heated hose. The second temperature may be between 40° F. and 60° F. greater than the first temperature, and the first temperature is be between 80° F. and 120° F. and the second temperature is between 135° F. and 160° F.

In one example, the preheaters may be electric heaters, each powerable by less than 1500 W or less than 1000 W. The one or more pumps, electric heaters, and heating elements may be powered at a same 220-240 VAC outlet. Each heated hose may extend approximately 200 linear feet between their receiving end and delivery end. Each heated hose may have an inner diameter of approximately ½ inch. A diameter of one or more of the heating elements may be up to ⅛ inch, for example.

In another aspect, a spray proportioner system includes a frame, a hopper housing, a heated hose, and a flow system. The hopper housing may be mounted to the frame to support a first hopper containing a first spray component and a second hopper containing a second spray component. The heated hose may include a first heated hose having a first heating element and extend between a receiving end and a delivery end. The heated hose may also include a second heated hose having a second heating element and extend between a receiving end and a delivery end. The a fluid flow system may include a first fluid path and a second fluid path. The first fluid path may have a first suction line including a first heater and that extends from the first hopper to a first recirculation manifold. The first fluid path may also include a first delivery line including a first heated hose and that extends from the first recirculation manifold to the delivery end of the first heated hose. The first fluid path may further include a first return line extending from the first recirculation manifold to the first hopper. The second fluid path may have a second suction line including a second heater and that extends from the second hopper to a second recirculation manifold. The second fluid path may also have a second delivery line including a second heated hose and that extends from the second recirculation manifold to the delivery end of the second heated hose. The second fluid path may also having a second return line extending from the second recirculation manifold to the first hopper.

The spray proportioner system may also include a valve associated with the first recirculation manifold and a valve associated with the second recirculation manifold. The valves may be operable to selectively transition the respective fluid paths between a delivery mode and a recirculation mode. In delivery mode, the respective recirculation manifold fluidically couples the respective suction line and delivery line. In recirculation mode, the respective recirculation manifold fluidically couples the respective suction line and return line.

The spray proportioner system may further include a first pump, a second pump, and an electrical motor. The first pump may pump the first spray component along the first fluid path, and the second pump may pump the second spray component along the second fluid path. The electrical motor may drive the first pump and the second pump.

The first and second heated hoses may each extend approximately 200 linear feet between their receiving end and delivery end and be configured to heat the respective first and second spray components from a first temperature taken at their receiving end to a second temperature taken at their delivery end. The second temperature may be at least 40° F. greater than the first temperature when the spray component is flowed at an operating pressure up to 2000 psi and a rate up to 12 lb/minute.

In various embodiments, the electric motor, first and second heaters, and first and second heated hoses may be powered at a same 220-240 VAC outlet. The second temperature may be between 40° F. and 60° F. greater than the first temperature, and the first temperature may between 80° F. and 120° F. and the second temperature may be between 135° F. and 160° F. In one example, the first hopper and second hopper may each be between 5 gallon and 10 gallon. In one embodiment, the second temperature may be at least 60° F. In one embodiment, each of the first and second heating elements has a diameter of approximately ⅛ inch and a length of approximately 400 feet. Each of the first and second heated hoses may have an inner diameter of approximately ½ inch through which the respective first and second spray component flow. The first heating element and second heating element may each have a length of approximately 400 feet that extends within the inner diameter of the respective first heated hose and second heated hose.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a schematic of a spray proportioner system according to various embodiments described herein;

FIG. 2 is an elevated perspective view of a spray proportioner system positioned according to various embodiments described herein;

FIG. 3 is a semi-schematic showing fluid flow through the recirculation manifold according to various embodiments described herein;

FIG. 4 is a semi-schematic of a heated hose and controller for a spray proportioner system according to various embodiments described herein;

FIG. 5 is a cross-sectional view of a heated hose for a spray proportioner system according to various embodiments described herein; and

FIG. 6 illustrates a heated hose manifold according to various embodiments.

### DESCRIPTION

Described herein are electric spray proportioners, components for operation with spray proportioners, and methods thereof that provide high spray outlet temperatures, e.g., greater than 150° F., 160° F., 170° F., or 180° F. The spray proportioner may be conveniently powerable to produce such temperatures for multiple fluid lines. Various embodiments may be powerable using a standard residential 220-240 VAC or equivalent supply. For example, power requirements may be met at a 240 VAC, 50 Amp outlet or on a generator producing 240 VAC, 1 phase, 60 Hz. In one embodiment, power requirements may be met using a 240 VAC, 40 Amp outlet. The power provided through the outlet connection may power the pumps for pumping the spray components as well as the heaters for heating the spray components, which may include onboard heaters as well as heated hoses.

Also described herein are heated hoses configured to generate ΔT when coupled with a spray proportioner system; that is, a heated hose configured to increase the temperature of a spray component that is flowed through the hose at operation pressure. For example, in some embodiments, a heated hose may increase the temperature of the spray component by 40° F., 50° F., 60° F., or more when flowed through the hose at operating pressure., e.g., up to 2000 psi with a 12 lb/minute volumetric flow rate. In one example, two separate spray components may be pulled from hoppers and each flowed through a primary/preheater. The temperature of each spray component pulled from the hopper may be approximately 60° F. to 80° F. The heaters may heat each of the spray components to approximately 80° F. to 120° F., such as approximately 90° F. to 110° F. Each of the now preheated heated spray components may be circulated to a heated hose. The inner diameter of the heated hose may be approximately ½ inch. The heated hose may include heating elements that extend within the hose to contract the spray component as it is flowed through the hose. The heated hose may be approximately 200 feet in length. In operation, the heating elements may heat spray component to a final temperature of up to 160° F. or 170° F., such as 140° F., as it is pumped through the hose to a spray nozzle at an operating pressure of up to 2000 psi with a volumetric flow rate of up to approximately 12 lb/minute.

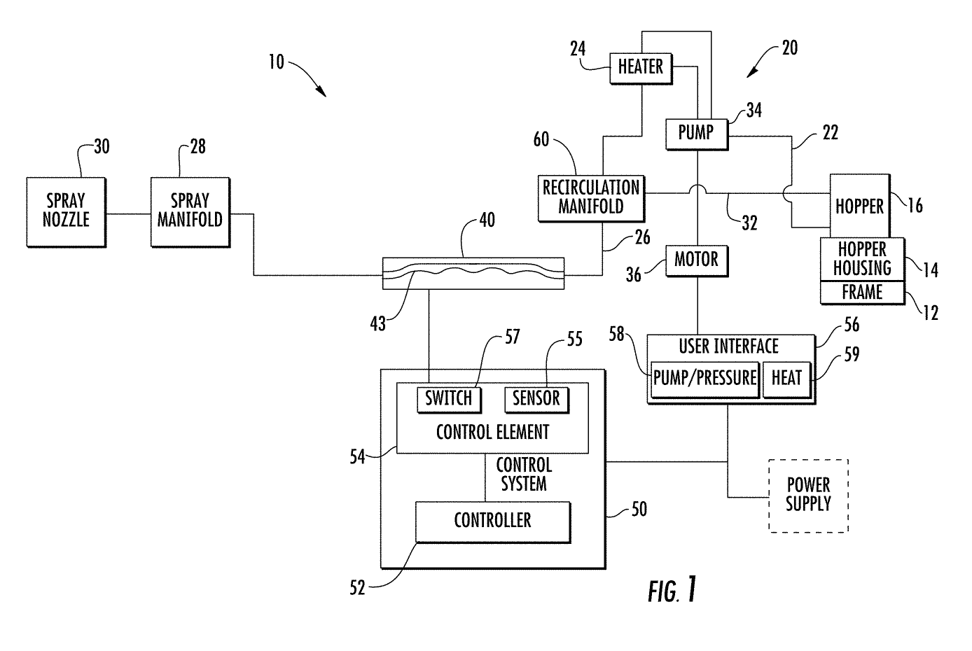

The spray proportioner system and components for use with spray proportioner systems are described below with reference to FIGS. 1-5, wherein like numerals indicated like features.

With reference to FIG. 1, a spray proportioner system 10 may include a frame 12 structured to mount various components of the spray proportioner system 10. The frame 12 may be structured for mobility. For example, the frame 12 may be supported by wheels that may be used to move and maneuver the spray proportioner system 10. A hopper housing 14 may be provided on the frame 12 onto which two or more hoppers 16 for containing spray component to be proportioned by the spray proportioner system 10 may be removably mounted for easy exchange of empty hoppers 16 with replacement hoppers 16. Hoppers 16 may be configured in convenient sizes such as between 5 gallon and 10 gallon buckets. For example, hoppers 16 may include 5 gallon, 7 gallon, or 10 gallon buckets for containing spray component to be proportioned.

The spray proportioner system 10 may also include a fluid flow system 20 including one or more suction lines 22 for fluidically coupling the hoppers 16 to one or more heaters 24. The one or more heaters 24 may be referred to as onboard heaters 24 mounted to the frame 12. The one or more heaters 24 may include any suitable heating technology, e.g., heating elements employing heated circulating fluid, resistance, IR, combustion, etc. The fluid flow system 20 may also include one or more delivery lines 26 for fluidically coupling the one or more heaters 24 to a spray manifold 28 for mixing spray components and a spray nozzle 30 structured to spray the mixed spray component in a combined stream. The fluid flow system 20 may include a valve operable to fluidically couple the spray manifold 28 to one or more of the delivery lines 26. The valve may be actuatable via a trigger of a spray gun.

The fluid flow system 20 may further include one or more return lines 32 for fluidically coupling hoppers 16 and the recirculation manifold for returning spray component that is not delivered into the delivery lines 26 back to the hoppers 16.

The fluid flow system 20 may also include one or more pumps 34 for circulating spray component from the hopper 16 throughout fluid flow system 20 of the spray proportioner system 10. The spray proportioner system 10 also includes one or more motors 36 to power the one or more pumps 34. In some embodiments, the pumps 34 may be driven by electric, pneumatic, hydraulic, combustion, or other type of motor 36.

In various embodiments, the delivery line 26 may include a heated hose 40 including one or more heated lengths of hose, e.g., fluidically coupled lengths or non-fluidically coupled lengths of hose. The heated hose 40 may be configured to apply thermal energy to the spray component that is in addition to the thermal energy applied by the one or more heaters 24 mounted to the frame 12 between the suction line 22 and the delivery line 26. The heated hose 40 may be structured to impart energy to the spray component being flowed through the heated hose 40. The heated hose 40 may include one or more heating elements 43 that extend within a flow path of an inner diameter of the one or more heated lengths of the heated hose 40. Heating element 43, or thermally conductive or thermally transparent housing thereof, may directly contact the spray component when flowed through the one or more heated lengths of heated hose 40.

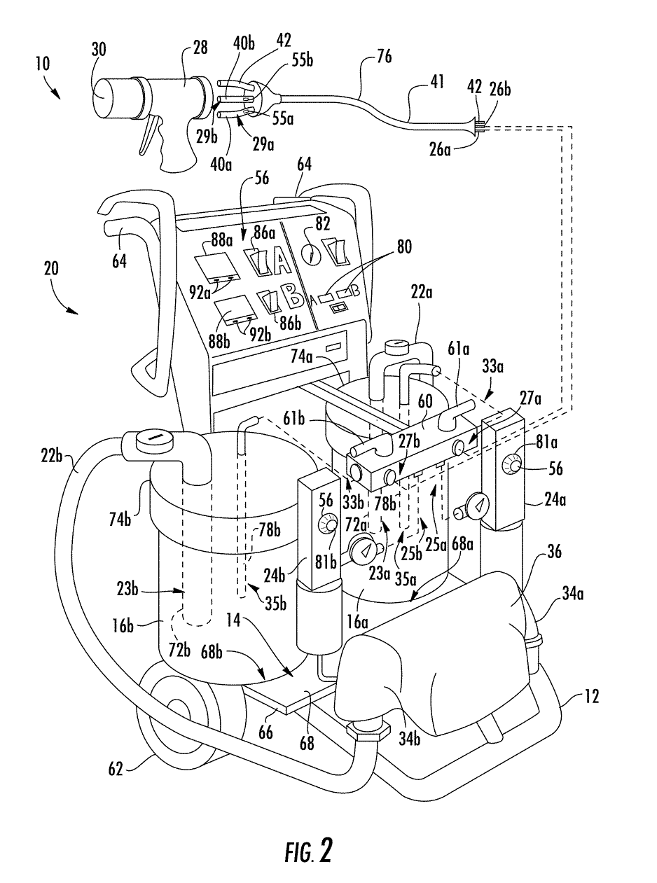

As described with respect to FIG. 2, the spray proportioner system 10 separately heats and delivers at least two spray components. Separate pumps 34 may be used to flow each spray component through a separate heater 24 and through separate heated hoses 40. In various embodiments, each heater 24 may be up to a 1500 watt heater, less than 1500 watt, such as 1000 watt. The energy imparted to the spray component by the heated hose 40 increases the temperature of the spray component—providing a ΔT. For example, the heated hose 40 may be structured to heat, via energy transferred from the one or more heating elements 43, the spray component flowed through the one or more heated lengths of heated hose 40 an additional 60° F. before the spray component reaches the nozzle 30 when the received by the hose 40 with a starting temperature between 80° F. and 90° F. In one such embodiment, the increase in temperature may be obtained with a heated hose 40 comprising approximately 200 feet in length wherein the component may be flowed at up to 12 lb/minute with a duty cycle of 80%. In a further embodiment, the spray component may be pulled from the hopper at approximately 60° F. After flowing through the heater 24, the spray component may enter the heated hose 40 at a temperature between approximately 100° F. to 120° F. After flowing through the 200 feet of heated hose at up to 2000 psi operating pressure at a rate of up to 12 lb/minute, the spray component may be sprayed from the nozzle 30 at a temperature of up to 160° F. The heated hose 40 may be powered from the same power source, as described herein, powering the electric motor 36 driving the pump 34.

The spray proportioner system 10 may also include a control system 50 including one or more circuits. The one or more circuits may include one or more controllers 52. The control system 50 may also include various control elements 54 in signal communication, e.g., in circuit, with the controller 52. Control elements 54 such as sensors 55 may measure operation data such as flow, pressure, temperature, or other data and provide the data to the controller 52. The controller 52 may analyze the measured data and transmit control instructions to control elements 54, such as switches 57, e.g., relays, actuators, etc., to modify operations of the spray proportioner system 10 in response to the measured data. In various embodiments, one or more functionalities of a control element 54 and controller 52 may be integrated.

In one embodiment, the control system 50 includes one or more circuits to monitor or control flow rates to meter spray component through the fluid flow system 20. For example, a controller 52 may include or be communicably coupled to a control element 54 comprising a sensor 55 to measure flow, such as a flow meter. The sensor 55 may transmit control data comprising flow data to the controller 52. The controller 52 may analyze the control data and signal one or more control elements 54 comprising a switch 57 to modulate an operation of one or more pumps 34 to obtain a desired set point flow rate or range of flow rate.

In various embodiments, the controller 52 may include or be communicably coupled to a control element 54 comprising one or more sensors 55 configured to measure and transmit to the controller 52 control data comprising measured temperature data of circulating spray component at one or more locations along the flow path of the fluid flow system 20. The controller 52 may use the measured temperature data to modulate heating operations to heat the spray component to a calculated or predefined set point temperature at one or more locations along the flow path of the fluid flow system 20. In one embodiment, the controller 52 analyzes the measured temperature data and signals a control element 54, such as switch 57, to terminate or initiate power supply to a heating device, such as heater 24, a heating element 43 of the heated hose 40, or combination thereof when the temperature data indicates that the temperature of the spray component is above or below a calculated or predefined temperature. In some embodiments, the controller 52 analyzes measured temperature data and provides proportional control by modulating amount of power supplied as temperature approaches a set point, e.g., by signaling control elements 54 to reduce instantaneous power or average power over a timer interval to heater 24, heating element 43, or combination thereof. In various embodiments, the controller 52 may analyze measured temperature data measured by sensor 55 in the delivery line 26 at a location adjacent to the spray manifold 28, e.g., along a whip portion or at the end of the heated hose and beginning of the whip portion. Based on the analysis the controller 52 may signal one or more control elements 54 to modulate power supply to heating element 43 such that spray component delivered to the spray manifold 28 is at a calculated, set point, or predefined range of temperature. For example, in various embodiments, the control system 50 includes one or more controllers 54 comprising a PID controller configured to receive and analyze measured temperature data and signal control elements 54, such as switch 57, to regulate temperature of circulating spray component. In one configuration, switch 57 includes a solid-state relay. The PID controller may be in signal communication with the solid-state relay to modulate thermal energy output or power delivery to heating element 43. In a further embodiment, the PID controller may use the measured temperature data to modulate heater 24, which may be multiple heaters 24. In some embodiments, the controller 52 incorporates a network of temperature sensors 55 and switches 57 to modulate the heating operations of the heated hose 40 and heater 24. The control system 50 may include separate controllers 52 and control elements 54 operable to control fluid flow and heating of separate spray components.

The spray proportioner system 10 may also include a user interface 56 for interfacing a user with the operations of control system 50. The user interface 56 may include one or more control panels, gages, indicators, touch screens, hard or soft control knobs or switches for defining and monitoring the operations of the fluid flow system 20 via the control system. As shown, the user interface 56 includes a pump/pressure interface 58 for interfacing the user with operation of pumps 34 to control or monitor system pressure. The user interface 56 also includes a heat interface 59 for interfacing the user with heating operations to control or monitor system heat.

As introduced above, spray component may be returned to the hopper 16 via a return line 32. The suction line 25 may direct spray component into a recirculation manifold 60. The recirculation manifold 60 may include one or more valves operable to direct flow of spray component to the delivery line 26 and block flow of spray component to the return line 32. The recirculation manifold 60 may also include one or more valves operable to direct flow of spray component to the return line 32 and block flow of spray component to the delivery line 26, e.g., to operate in a recirculation mode.

FIG. 2 illustrates an embodiment of a spray proportioner system 10 according to various embodiments. The spray proportioner system 10 includes a mobile frame 12 structured to mount various components of the spray proportioner system 10. The frame 12 is supported above ground level by two wheels 62. A first wheel 62 (not visible) is mounted to a lower end of the frame 12 at a first axle end along a first side of the frame 12. A second wheel 62 is mounted to the lower end of the frame 12 at a second axle end along a second side of the frame 12. Handles 64 dimensioned to be grasped by a user to maneuver the frame 12 are positioned at an upper end of the frame 12 and extend horizontally outward from the frame 12, rear of the wheels 62.

The spray proportioner system 10 includes a hopper housing 14 comprising a base plate 66. The base plate 66 is attached to the frame 12 and includes a mounting surface 68 comprising a first portion 68a and a second portion 68b. The first portion 68a extends from the first side of the frame 12, above the first wheel 62 (not visible), to the second portion 68b of the base plate 66. The second portion 68b of the base plate 66 extends from the first portion 68a to the second side of the frame 12, above the second wheel 62. The base plate 66 is dimensioned to support removable hoppers 16a, 16b containing a supply of spray component. For example, the first portion 68a is dimensioned to support a first hopper 16a and the second portion 68b is dimensioned to support a second hopper 16b. As shown, the first portion 68a of the mounting surface 68 is dimensioned to support a first hopper 16a comprising a 5 gallon to 10 gallon bucket containing a first spray component and the second portion 68b is dimensioned to support a second hopper 16b comprising a 5 gallon to 10 gallon bucket containing a second spray component. Other bucket sizes may be used. The first and second portions 68a, 68b of the mounting surface 68 are generally flat. In other embodiments, however, one or both of the first and second portions 68a, 68b of the mounting surface 68 are contoured to fit base dimensions of hoppers 16a, 16b, e.g., buckets. The hoppers 16a, 16b may be clamped or strapped to the frame 12 to secure the hoppers 16a, 16b during use or transport.

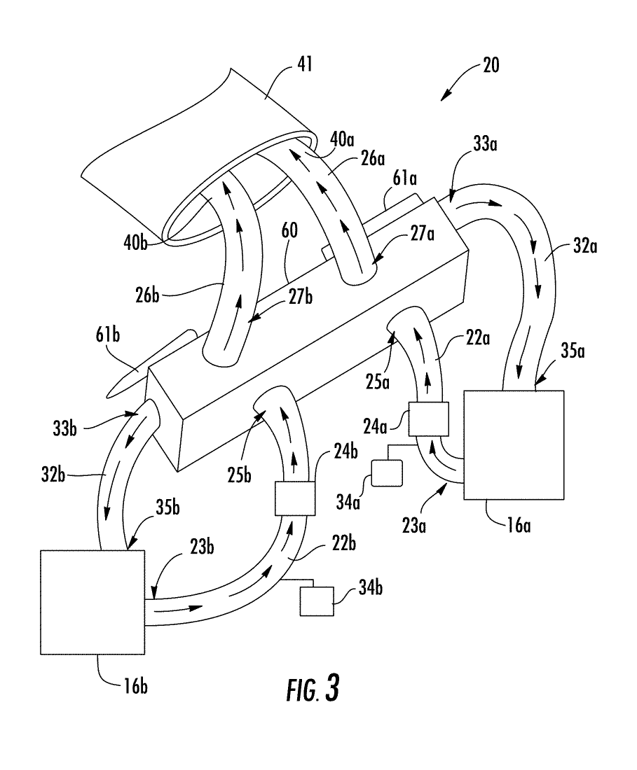

The spray proportioner system 10 includes a fluid flow system 20 configured to heat spray component and deliver the heated spray component to a spray manifold 28 for distributing the heated components and a spray nozzle 30 for spraying the mixed heated components in a combined stream. With continued reference to FIG. 2 together with FIG. 3, semi-schematically illustrating the flow scheme of fluid through the fluid flow system 20, the fluid flow system 20 includes a first suction line 22a fluidically coupling the first hopper 16a at a first end 23a, a first heater 24a, and a recirculation manifold 60 at a second end 25a. The first suction line 22a may comprise one or more hoses that extend between the first heater 24a and the first hopper 16a and the first heater 24a and the recirculation manifold 60. The first end 23a of the first suction line 22a may include a suction tube 72a configured to extend into the first hopper 16a. The suction tube 72a is coupled to or is coupleable to a lid 74a. The lid 74a may be dimensioned to be removably attached to the first hopper 16a to couple the spray component therein to the fluid flow system 20. A second suction line 22b fluidically couples the second hopper 16b at a first end 23b, a second heater 24b, and the recirculation manifold 60 at a second end 25b. The second suction line 22a may comprise one or more hoses that extend between the second heater 24b and the second hopper 16b and the second heater 24b and the recirculation manifold 60. The first end 23b of the second suction line 22b may include a suction tube 72b configured to extend into the second hopper 16b. The suction tube 72b by be coupled to or coupleable to a lid 74b. The lid 74b may be dimensioned to be removably attached to the second hopper 16b to couple the spray component therein to the fluid flow system 20.

The first heater 24a and the second heater 24b are mounted to the frame 12. The heaters 24a, 24b may each be rated at between 600 watts and 1500 watts, such as approximately 650 watts, approximately 850 watts, approximately 1000 watts, or approximately 1,200 watts.

A first pump 34a is operatively coupled to the first suction line 22a between the first hopper 16a and the second heater 24b to pull spray component from the first hopper 16a and circulate it through the fluid flow system 20. A second pump 34b is operatively coupled to the second suction line 22a between the second hopper 16b and the second heater 24b to pull spray component from the second hopper 16b and circulate it through the fluid flow system 20. In other embodiments, additional or fewer pumps 34a, 34b may be used, e.g., multiple first or second pumps 34a, 34b, a shared pump, etc. The spray proportioner system 10 also includes an electrical motor 36 to drive the pumps 34a, 34b. The electrical motor 36 in cooperation with the pumps 34a, 34b may be operable to provide a maximum operating pressure between 0 psi and 2000 psi, such as approximately 1500 psi, approximately 1750 psi, or approximately 2000 psi. The spray proportioner system 10 may include a power cord for coupling to a suitable outlet to power the electrical motor 36. In various embodiments, suitable outlets may include 220 VAC, 40 Amp; 240 VAC, 1 phase, 60 Hz; equivalents; as well as other power supplies described herein. In some embodiments, additional motors may be used.

The fluid flow system 20 includes the recirculation manifold 60, which is operable to selectively distribute the spray component received from the suction lines 22a, 22b. The recirculation manifold 60 includes a first valve 61a for selectively distributing spray component received from the first suction line 22a and a second valve 61b for selectively distributing spray component received from the second suction line 22b. In a delivery position, each valve 22a, 22b directs spray component to a respective first delivery line 26a and second delivery line 26b. The delivery lines fluidically couple the recirculation manifold 60 at first ends 27a, 27b to a spray manifold 28 at second ends 29a, 29b. The first and second delivery lines 26a, 26b may each comprise one or more hoses. As shown, the first and second delivery lines 26a, 26b each include a respective heated hose 40a, 40b. The first heated hose 40a and the second heated hose 40b are illustrated in heated hose bundle 41. Exemplary lengths of first and second heated hoses 40a, 40b include 50 feet to 250 feet, 100 feet to 250 feet, 100 feet to 200 feet, 150 feet to 200 feet, or approximately 200 feet, such as 190 feet, 210 feet, or 220 feet. A whip portion may be coupled between the spray manifold 28 and the heated hose 40a, 40b. In various embodiments, the first heated hose 40a and second heated hose 40b may be structured for operational pressures up to approximately 1500 psi, up to approximately 2000 psi, or above. As shown, the first heated hose 40a and second heated hose 40b are structured for operational pressures up to approximately 2000 psi.

The fluid flow system 20 is further configured to circulate spray component back into the hoppers 16a, 16b. For example, in a recirculation position, each valve 22a, 22b directs spray component to a respective first return line 32a and second return line 32b. The return lines 32a, 32b fluidically couple the recirculation manifold 60 at first ends 33a, 33b to the respective hopper 16a, 16b at second ends 35a, 35b. The first return line 32a may comprise one or more hoses that extend between the recirculation manifold 60 and the first hopper 16a. The second end 35a of the first return line 32a may include a return tube 78a extendable into the first hopper 16a. The return tube 78a may comprise or be removably coupleable to lid 74a. In one example, the lid 74a includes a fitting dimensioned to couple to the return tube 78a. The lid 74a may also include fittings for or be connected to the first suction line 22a, as described above. The second return line 32b may comprise one or more hoses that extend between the recirculation manifold 60 and the second hopper 16b. The second end 35b of the second return line 32b may include a return tube 78b for coupling the return line 62b to the second hopper 16b. The return tube 78b may comprise or be removably coupleable to lid 74b. In one example, lid 74b includes a fitting dimensioned to couple to the return tube 78b. The lid 74b may also include fittings for or be connected to the second suction line 22a, as described above.

In operation, the first and second pumps 34a, 34b may be operated to pull spray component through the first suction line 22a and the second suction line 22b from the first hopper 16a and the second hopper 16b, respectively, and pass the spray component through the respective first heater 24a and second heater 24b. The first heater 24a and second heater 24b may heat the respective spray component to a first temperature, e.g., between 80° F. and 100° F., while the spray component moves through the respective first heater 24a and second heater 24b. After exiting the first heater 24a and second heater 24b, each spray component is pumped along the respective suction line 22a, 22b to the recirculation manifold 60. When the valves 61a, 61b of the recirculation manifold 60 are in the delivery position, the spray components are directed into respective delivery lines 26a, 26b toward the spray manifold 28. The delivery lines 26a, 26b include respective heated hoses 40a, 40b operable to further heat the spray components to a second temperature, greater than the first temperature, as they pass along the delivery lines 26a, 26b to a second temperature. In various embodiments, the second temperature is between 30° F. and 60° F. greater than the first temperature. In one example, the first temperature is about 80° F. and the second temperature is about 140° F. In another example, the first temperature is about 90° F. and the second temperature is about 130° F. As also described herein, the spray proportioner system 10 may be set to apply differential heat to the spray components along the suction lines 22a, 22b, delivery lines 26a, 26b, or both to achieve a desired second temperature at the spray manifold 28. Thus, depending on the desired second temperature and the first temperature of the spray components received, the heating energy output by the heated hoses 40a, 40b may be modulated to achieve the desired second temperature, e.g., employing a thermocouple. The first temperature and the second temperature along the first delivery line 26a may be the same or different than the first temperature and second temperature along the second delivery line 26b. At the second ends 29a, 29b of the first delivery line 26a and second delivery line 26b, the respective spray component may be delivered to the spray manifold 28 for release from the spray nozzle 30 in a combined stream. The hose bundle 41 also includes an air line 42 for coupling a supply of compressed air to the spray manifold to create a combined foam stream.

The first heated hose 40a and second heated hose 40b may be removable from the spray proportioner system 10, e.g., they may be a modular components. The first heated hose 40a and second heated hose 40b may include electrical couplings to couple to a supply of power. In one example of the illustrated embodiment, the first heated hose 40a and second heated hose 40b electrically couple to the power source through the spray proportioner system 10 via a plug or other connection.

As exemplified by the embodiment illustrated in FIG. 2, the fluid flow system 20 may be configured to heat each spray component at two locations along the fluid flow path, before and after the recirculation manifold 60 and including the heated hose 40a, 40b. Unlike current hoses configured to maintain heat, the present heated hoses 40a, 40b are designed within the system 10 to increase the temperature of the spray component as it is pumped along the first delivery line 26a or second delivery line 26b after being initially heated by the first heater 24a or second heater 24b. This configuration allows greater control over final temperature, e.g., second temperature, at which the spray components are sprayed, than spray systems that use only primary heaters/preheaters or primary heaters/preheaters and hoses operable to maintain a first temperature imparted to the fluid by the primary/preheaters. This configuration also allows heating spray components supplied in 5 gallon to 10 gallon buckets, e.g., 5 gallon, 7 gallon, or 10 gallon hoppers and more precise operational temperatures than current systems and using lower power requirements than current high temperature systems that require supplying spray components from cumbersome 55 gallon drums.

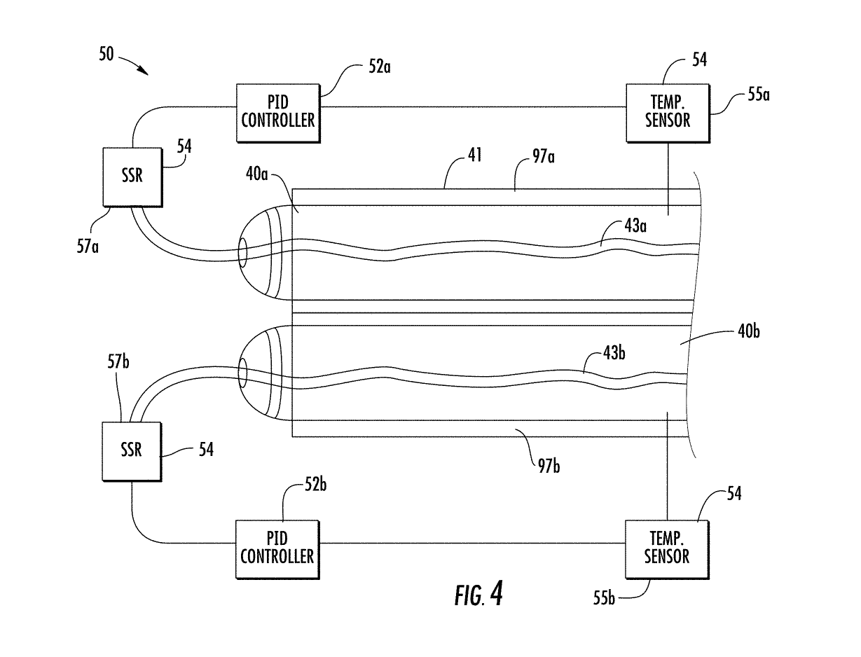

With continued reference to FIG. 2, the spray proportioner system 10 also includes a control system 50 configured to control operations of the spray proportioner system 10, e.g., the fluid flow system 20. The control system 50 includes a user interface 56 positioned at an upper end of the frame 12. The control system 50 may include controllers and control elements as described above with respect to FIG. 1 and elsewhere herein. For example, the control system 50 may include one or more control elements comprising temperature sensors positioned to measure temperature of flowing spray component along the flow path and provide the temperature data to one or more controllers. The controller may analyze the temperature data and utilize control elements such as switches to modulate heat output at one or more points along the flow path. In the illustrated embodiment, the control system 50 includes temperature sensors 55a, 55b positioned along the second ends 29a, 29b of the delivery lines 26a, 26b, adjacent to the spray manifold 28. Optionally, the control system 50 may also include temperature sensors (not shown) positioned between the first or second heaters 24a, 24b and the recirculation manifold 60. Upon receipt of the measured temperature data, the controller may analyze the data and respond by adjusting or maintaining power supplied to the heater 24a, 24b, heated hose 40a, 40b, or both, thereby modulating energy transferred therein to the flowing spray component. For example, as introduced above with respect to FIG. 1 and explained in additional detail below with respect to FIG. 4, a controller may provide a control signal to a control element such as a relay switch to modulate power supplied to a heated hose 40a, 40b or heater 24a, 24b, e.g., switch power on, off, or make a proportional adjustment, to achieve the desired second temperature at the spray nozzle 30.

The user interface 56 includes heat interfaces comprising temperature displays 80 for spray components taken between the heaters 24a, 24b and the recirculation manifold 60. The user interface 56 also includes a pump/pressure interface comprising a temperature knobs 81a, 81b and control knob 82. The temperature knobs 81a, 81b are operable to control heating power generated by the heaters 24a, 24b. The control knob 82 may be turned to select a function such as stopping motor 36, modulating recirculation speed when the valves 61a, 61b are in the recirculation position, or adjusting fluid pressure to spray nozzle 30 when the valves 61, 61b are in the delivery position.

The user interface 56 also includes heat interfaces configured to interface a user with operations of the heated hose. In the illustrated embodiment, the user interface 56 includes a power switches 86a, 86b for powering each of the heated hoses 40a, 40b. Displays 88a, 88b for each heated hose 40a, 40b to display a current or set temperature, such as a measured or desired second temperature. Buttons 92a, 92b are also provided through which a user may interface with the settings of the control system 50. For example, a user may press one or more buttons 92a, 92b to program temperature set points, desired temperature range, or control algorithm used by a controller of the control system 50 to analyze temperature data to correspondingly modulate the heated hose 40a, 40b or, in one embodiment, heaters 24a, 24b

The spray proportioner system 10 may include additional or fewer components. For example, the spray proportioner system 10 may include a skid plate attached to the lower end of the frame 12 between the first side and second side of the frame 12 and extending forward of the first and second wheels 26. The control system 50 may include temperature sensors at multiple locations such as along a suction line 22a, 22b between a hopper 16a, 16b and heater 24a, 24b, along a delivery line 26a, 26b between a heater 24a, 24b and heated hose 40a, 40b, along a delivery line 26a, 26b between a heated hose 40a, 40b and the spray manifold 28, or combinations thereof. The control system 50 may analyze measured temperature data from one or more sensors individually or together to properly modulate power supplied to a heater 24a, 24b, or heated hose 40a, 40b. It will be appreciated that the control system 50 may include multiple controllers. The multiple controllers may or may not be in communication. For example, the operation of the first heated hose 40a may be under the control of a first controller and the operation of the second heated hose 40b may be under the control of a second controller wherein the first and second controllers may or may not communicate or share data. In a further embodiment, the operation of the first heater 24a and the second heater 24b may be under the control of the first and second controllers or additional controllers that may or may not communicate or share data. In some embodiments, the control system 50 of the spray proportioner system 10 of FIG. 2 is configured to include features similar to those described below respect to the controllers for the heated hose 40a, 40b of FIG. 4.

FIG. 4 semi-schematically illustrates features of a control system 50 for controlling heating of a heated hose according to various embodiments. The control system 50 includes a first controller 52a configured to measure and regulate temperature of the circulating spray component by modulating the power supplied or energy output of a first heated hose 40a. In the illustrated embodiment, the first controller 52a is a PID controller; however, in other embodiments, different types of controllers may be used. The first controller 52a is in signal communication with control elements 54 comprising a temperature sensor 55a configured to collect measured temperature data and a relay switch 57a, which in this embodiment comprises solid state relay (SSR) configured to modulate power delivery to a heating element 43a of the first heated hose 40a. The control system 50 also includes a second controller 52a configured to measure and regulate temperature of circulating spray component by modulating the power supplied or energy output of the second heating hose 40b. In the illustrated embodiment, the second controller 52b is a PID controller; however, in other embodiments, different types of controllers may be used. The second controller 52b is in signal communication with control elements 54 comprising a temperature sensor 55b configured to collect measured temperature data and a relay switch 57b, which in this embodiment comprises solid state relay (SSR) configured to modulate power delivery to a heating element 43a of the second heated hose 40b.

The temperature sensors 55a, 55b may be positioned to collect temperature data at any location between a spray nozzle and recirculation manifold (see, e.g., FIG. 2). For example, the temperature sensor 55a, 55b may be positioned at the second end of the delivery line. As described above with respect to FIGS. 1 and 2, additional temperature sensors may also be used, e.g., along a suction line or another position along the delivery line. Each of the heating elements 43a may include one or more heating elements that extend within the flow path of the respective heated hose 40a, 40b, which in this embodiment includes a ½ inch inner diameter of a foam insulated hose 97a, 97b. Other diameters and thermal insulation materials may be used. As described above, in a further embodiment, the controllers 52a, 52b may use measured temperature data to modulate one or more additional heaters, such as a primary or preheater (see, e.g., FIG. 2). In some embodiments, each of the controllers 52a, 52b incorporate a network of temperature sensors 55a, 55b and switches 57a, 57b to modulate heating operations of the heated hoses 40a, 40b.

In various embodiments, the first controller 52a, second controller 52b, temperature sensor 55a, temperature sensor 55b, switch 57a, switch 57b, or a combination thereof may be bundled 41. For example, the bundle 41 may include electrical connections configured to couple to the power supplied to the spray proportioner system. In this or another embodiment, the first controller 52a, second controller 52b, temperature sensor 55a, temperature sensor 55b, switch 57a, switch 57b, or a combination thereof may be housed in a controller housing mounted to the frame (see, e.g., FIG. 2). Coupling the heated hose 40a, 40b to the spray proportioner system may include coupling electrical connections, e.g., power supply plugs, as described above, to the spray proportioner system as described above. In this or other embodiments, coupling the heated hose 40a, 40b to the spray proportioner system includes coupling additional electrical connections, such as those connected to temperature sensors 55a, 55b to establish one or more communication links between temperature sensors 55a, 55b and the respective first controller 52a and second controller 52b.

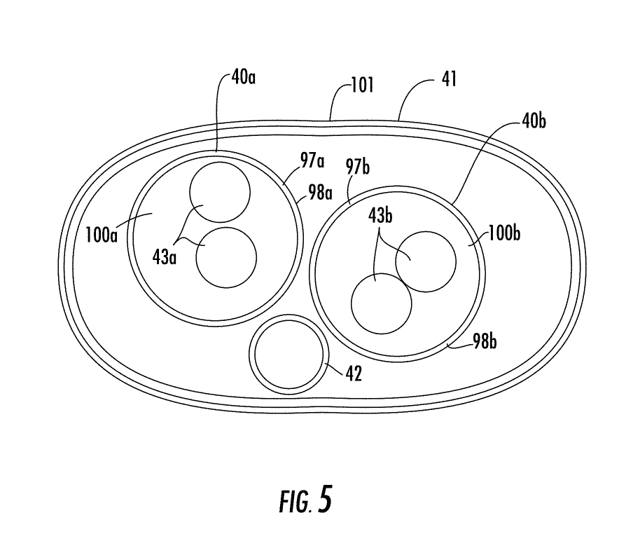

FIG. 5 illustrates a cross-section of a hose bundle 41 according to various embodiments. In various embodiments, the heated hose described above with respect to FIGS. 1-4 is structured as illustrated in FIG. 5. The hose bundle 41 includes a first heated hose 40a and a second heated hose 40b, each comprising an insulated hose 97a, 97b. The insulated hoses 97a, 97b may include durable coverings such as a thermoplastic or other suitable material. The insulated hoses 97a, 97b include foam insulated walls 98a, 98b, each defining a flow path 100a, 100b within an inner diameter. A heating element 43a, 43b extends within the flow path 100a, 100b to therein contract spray component flowing within the inner diameter. The bundle 71 also includes an air line 42 through which a supply of compressed air may be directed from an air compressor to the spray manifold. The bundle 71 may include a covering, such as a Kevlar or nylon sheath, housing the heated hoses 40a, 40b, and air line 42.

The heating elements 43a, 43b may include various materials such as a fluoropolymer, e.g., PFA, PVDF, PTFE, or FEP, or other suitable material. The heating element 43a, 43b may include various sized and positioned dimensions. For example, the heating element 43a, 43b may be straight or include turns. The heating element 43a, 43b may have a high surface area along which to contact flowing spray component or otherwise radiate energy. For example, the surface area of the heating element 43a, 43b may be at least 0.5 ft² per linear foot of heated hose. In one embodiment, the surface area of the heating element 43a, 43b may be between 0.7 ft² and 0.8 ft² per linear foot of heated hose 40a, 40b. In some embodiments, the heating element 43a, 43b may have a textured surface that significantly increases surface area. The heating element 43a, 43b may extend along a central portion of one or more lengths of the flow path 100a, 100b. The heating element 43a, 43b may be spaced apart from or contact the walls 98a, 98b along one or more lengths of the flow path 100a, 100b. The heating element 43a, 43b may coil within the flow path 100a, 100b. As noted above, the heating elements 43a, 43b may extend within the heated hose 40a, 40b to contact flowing spray component. Therefore, the flow path 100a, 100b may be defined by both the heated hose 40a, 40b and heating element 43a, 43b. In one arrangement of the bundle 71 illustrated in FIG. 5, each heated hose 40a, 40b defines approximately ½ inch diameter through which the flow path 100a, 100b extends, although other dimensions may be used. In this or another embodiment, each heated hose 40a, 40b is fitted with approximately ⅛ inch heating elements 43a, 43b. Each of the heating elements 43a, 43b may include two or more ⅛ inch diameter elements that extend along all or a portion of the flow path 100a, 100b. Other diameters may be used. For example, a heated hose 40a, 40b may have a diameter between ⅓ inch and 1 ½ inch and the heating element 43a, 43b may include 1 or more elements having diameters or thicknesses between 1/16 inch and ¼ inch. As shown, each heating element 43a, 43b is approximately twice the length of the heated hose 40a, 40b and is turned or doubled over at one end of the heated hose 40a, 40b and ran back through the flow path 100a, 100b.

The bundle 71 or first heated hose 40a and second heated hose 40b may include electrical couplings to couple the heated hoses 40a, 40b to a supply of power. In one example of the illustrated embodiment, the first heated hose 40a and second heated hose 40b electrically couple to the power source through the spray proportioner system via a plug or other connection, which may be similar to the power supply requirements described above. When coupled to a spray proportioner, the heated hose 40a, 40b is configured may increase the temperature of the spray component having an initial temperature up to 100° F. by 40° F., 50° F., 60° F., or more when flowed through the hose at operating pressure and flow.

The bundle 71 or first heated hose 40a and second heated hose 40b may be removable from the spray proportioner system, e.g., they may be a modular components. For example, the bundle 71 illustrated in FIG. 5 may be used with the spray proportioner system 10 and associated features described above with respect to FIGS. 1-4 be powered through the same connection to a 240 VAC residential power supply or generator, as described above. In one such embodiment, the bundle 71 includes a heated hose 40a, 40b extending along a length of approximately 200 feet. The inner diameter of each hose 40a, 40b may be approximately ½ inch. The diameter of each heating element 43a, 43b approximately ⅛ inch or equivalent. The heating elements 43a, 43b may each have a length of approximately 400 feet extending within the respective flow path 100a, 100b. In one example, using an AR2929 tip, the spray component may be heated by the primary/preheaters and received by the hose 40a, 40b with a starting temperature between 80° F. and 90° F. The spray component may be flowed at up to 12 lb/minute with a duty cycle of 80% to obtain a spray temperature at the spray manifold of approximately 140° F. or more. In a further embodiment, the spray component may be pulled from the hopper at approximately 60° F. After flowing through the heaters, each spray component may enter the heated hose 40a, 40b at a temperature between approximately 100° F. to 120° F. After flowing through the 200 feet of heated hose at up to 2000 psi operating pressure at a rate of 12 lb/minute, the spray components may be delivery to the spray manifold and sprayed from the nozzle at a temperature of up to 160° F. If the user desires a final temperature of 140° F., the primary/preheaters may supply the spray component to the heated hose 40a, 40b at a temperature between 70° F. and 100° F., preferably between 80° F. and 90° F. After being lowed through the heated hose 40a, 40b at operating pressure, e.g., up to 2000 psi with up to 12 lb/minute volumetric flow rate, the heated hose may increase the temperature of the spray component to 140° F. Depending on the AT desired, the diameter of the heated hose 40a, 40b, diameter or surface area of the heating element 43a, 43b, and flow rate may be altered. For example, in the above embodiment, similar final temperatures may be obtained for spray components supplied at lower temperatures. Higher final temperatures may also be obtained by reducing the flow rate. For example, why a an increase in temperature of 60° F. may be obtained at 12 lb/minute, greater increases may be obtained at reduced flow rates. In another example, larger hose diameters with heating elements 43a, 43b having larger diameters or greater surface area may also be used. As described above, the heated hose 40a, 40b may be powered from the same power source powering the electric motor driving the pumps.

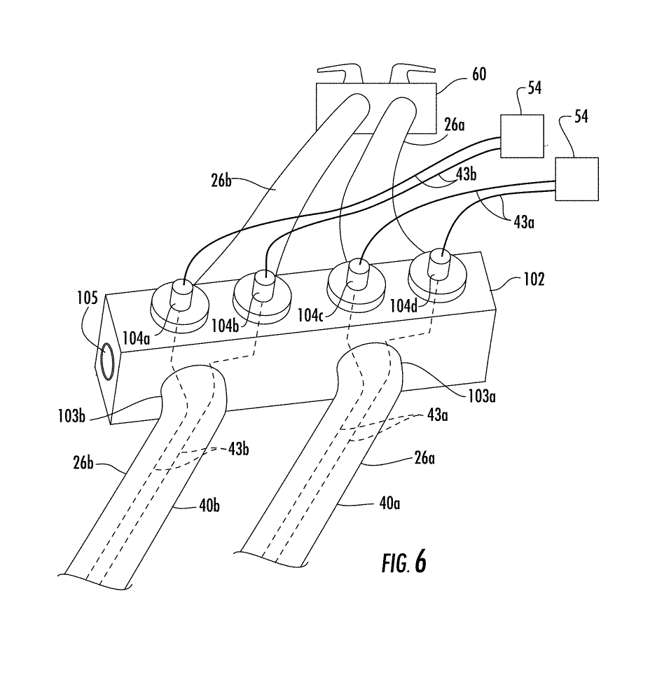

FIG. 6 illustrates a heated hose manifold 102 according to various embodiments. The heated hose manifold 102 is configured to receive spray component from the recirculation manifold 60 and direct the fluid to a heated hose 40a, 40b. Delivery lines 26a, 26b are tightly coupled to the heated hose manifold 102 to form a seal between the internal flow path of the delivery lines 26a, 26b and the external environment sufficient to maintain the internal operating pressure of 1500 psi, 1900 psi, 2000 psi, or greater. The heated hose manifold 102 may fluidically couple to the recirculation manifold 60 within the respective delivery lines 26a, 26b via hoses, as shown, or via other fluid conduits. In some embodiments, the heated hose manifold 102 may be attached to the recirculation manifold 60 or may be integrated with the recirculation manifold 60. The heated hose manifold 102 includes separate flow paths for each spray component and directs each spray component to a respective heated hose 40a, 40b. The heated hose 40a, 40b couples to the heated hose manifold 102 at fittings 103a, 103b located through the sides of the heated hose manifold 102. Plugs 105 may seal unused ports into the separate flow paths.

Heating elements 43a, 43b extend from the control elements 54, which may be switches, such a singles state relays, as described above, and into one of the separate flow paths through the heated hose manifold 102. Two heating elements 43a, 43b extend into each of the flow paths. The heating elements 43a, 43b further extend along the heated hoses 40a, 40b and together with the interior surface of each heated hose 40a, 40b define the flow path through heated hose 43a, 43b. The heated hose manifold 102 is fitted with connectors 104a, 104b, 104c, 104d through which the heating elements 43a, 43b pass into the separate flow paths in the heated hose manifold 102. As noted above, the operating pressure along the flow path may be up to approximately 2,000 psi or more. The connectors 104a, 104b, 104c, 104d may include a sealable passage through which the heating elements 43a, 43b extend. For example, the diameter of the passage may be reduced to compress against the heating elements to form a tight seal to maintain the high internal pressures of the system. In one embodiment, the connectors 104a, 104b, 104c, 104d may include threads along a first end that may be threadably coupled to the heated hose manifold 102. The connectors 104a, 104b, 104c, 104d may further include second ends having a head that may be rotated to reduce the diameter of the passages through the connectors 104a, 104b, 104c, 104d and compress against the heating element surface to tightly seal the connection. As described above, each heating element 43a, 43b may extend through the length of heated hose 40a, 40b twice, e.g., fold at one end of the hose 40a, 40b before looping back through. Thus, each heating element 43a, 43b may extend into the heated hose manifold 102, along a length of the heated hose 40a, 40b and back, and then extend out of the heated hose manifold 102.

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an application of the described embodiments. Further, the use of a singular noun includes the plural, and the use of a plural noun includes the singular, unless the context of the usage requires otherwise. Additionally, the grammatical conjunctions “and” and “or” are used herein according to accepted usage. By way of example, “x and y” refers to “x” and “y”. On the other hand, “x or y” refers to “x”, “y”, or both “x” and “y”, whereas “either x or y” refers to exclusivity.

This disclosure describes various elements, features, aspects, and advantages of various embodiments, configurations, and arrangements of a spray proportioner system, components for use with a spray proportioner system, and methods thereof. It is to be understood that certain descriptions of the various embodiments and such configurations and arrangements thereof have been simplified to illustrate only those elements, features and aspects that are relevant to a more clear understanding of the disclosed embodiments, while eliminating, for purposes of brevity or clarity, other elements, features and aspects. Any references to “various,” “certain,” “some,” “one,” or “an” when followed by “embodiment,” “configuration,” or “arrangement” generally means that a particular element, feature or aspect described in the example is included in at least one embodiment. The phrases “in various,” “in certain,” “in some,” “in one,” or “in an” when followed by “embodiment”, “configuration”, or “arrangement” may not necessarily refer to the same embodiment. Furthermore, the phrases “in one such” or “in this” when followed by “embodiment,” “configuration,” or “arrangement,” while generally referring to and elaborating upon a preceding embodiment, is not intended to suggest that the elements, features, and aspects of the embodiment introduced by the phrase are limited to the preceding embodiment; rather, the phrase is provided to assist the reader in understanding the various elements, features, and aspects disclosed herein and it is to be understood that those having ordinary skill in the art will recognize that such elements, features, and aspects presented in the introduced embodiment may be applied in combination with other various combinations and sub-combinations of the elements, features, and aspects presented in the disclosed embodiments. It is to be appreciated that persons having ordinary skill in the art, upon considering the descriptions herein, will recognize that various combinations or sub-combinations of the various embodiments and other elements, features, and aspects may be desirable in particular implementations or applications. However, because such other elements, features, and aspects may be readily ascertained by persons having ordinary skill in the art upon considering the description herein, and are not necessary for a complete understanding of the disclosed embodiments, a description of such elements, features, and aspects may not be provided. For example, ovens and oven systems described herein may also include connections such as fittings for one or more of electrical connections, gas connections, or flue connections. As such, it is to be understood that the description set forth herein is merely exemplary and illustrative of the disclosed embodiments and is not intended to limit the scope of the invention as defined solely by the claims.

1. A method of heating a spray component with a spray proportioner unit equipped with one or more pumps to flow two spray components along separate flow paths each extending from a respective container holding a supply of the spray component, through a respective preheater and respective heated hose, to a spray gun, the method comprising:
for each of two spray components
flowing the spray component from a hopper container to a preheater;
flowing the spray component from the preheater to a heated hose;
flowing the spray component along the heated hose from a receiving end to a delivery end of the heated hose at a rate up to 12 lb/minute; and
heating the spray component from a first temperature, taken at a first location along the receiving end, to a second temperature, taken at a second location along the delivery end, with one or more heating elements extending through the heated hose as the spray component flows through the heated hose between the first and second locations, wherein the second temperature is at least 30° F. greater than the first temperature.

2. The method of claim 1, wherein the second temperature is 40° F. to 60° F. greater than the first temperature, and wherein the first temperature is between 80° F. and °100° F. and the second temperature is between 130° F. and °160° F.

3. The method of claim 1, wherein the second temperature is 40° F. to and 60° F. greater than the first temperature, and wherein the first temperature is between 100° F. and 120° F. and the second temperature is between 135° F. and °160° F.

4. The method of claim 1, wherein the second temperature is 40° F. to and 60° F. greater than the first temperature, and wherein the first temperature is between 80° F. and 120° F. and the second temperature is between 135° F. and 160° F.

5. The method of claim 4, wherein the first and second locations along each heated hose are separated along the hose by approximately 200 linear feet.

6. The method of claim 4, wherein the first and second locations of each heated hose are separated by approximately 200 linear feet of the hose having an inner diameter of approximately ½ inch through which approximately 400 linear feet of approximately ⅛ inch diameter heating element extends.

7. The method of claim 6, further comprising powering the one or more pumps, electric heaters, and heating elements of the heated hoses at a same 220-240 VAC outlet.

8. The method of claim 1, wherein the heating elements extend within an inner diameter of the heated hoses between the first and second locations and define a portion of the flow path therebetween.

9. The method of claim 8, wherein the second temperature is 40° F. to 60° F. greater than the first temperature, and wherein the first temperature is between 80° F. and 120° F. and the second temperature is between 135° F. and °160° F.

10. The method of claim 9, further comprising powering the one or more pumps, electric heaters, and heating elements of the heated hoses at a same 220-240 VAC outlet.

11. The method of claim 10, wherein the preheaters are electric heaters, each powerable by less than 1500 W.

12. The method of claim 10, wherein the preheaters are electric heaters, each powerable by less than 1000 W.

13. The method of claim 10, wherein the first and second locations of each heated hose are separated along the hose by approximately 200 linear feet.

14. The method of claim 13, wherein each heated hose has an inner diameter of approximately ½ inch, and wherein a diameter of one or more of the heating elements is ⅛ inch.

15. A spray proportioner system, the system comprising:
a first heated hose having a first heating element and extending between a receiving end and a delivery end;
a second heated hose having a second heating element and extending between a receiving end and a delivery end;
a fluid flow system comprising
a first fluid path comprising
a first suction line configured to fluidically couple a container containing a first spray component to a first recirculation manifold,
a first delivery line including a first heated hose and fluidically coupling the first recirculation manifold to the receiving end of the first heated hose, and
a first return line configured to fluidically couple the first recirculation manifold to the first container, and
a second fluid path comprising
a second suction line configured to fluidically couple a second container containing a second spray component to a second recirculation manifold,
a second delivery line including a second heated hose fluidically coupling the second recirculation manifold to the receiving end of the second heated hose, and
a second return line configured to fluidically couple the second recirculation manifold to the second container;
wherein each of the first and second heated hoses is configured to heat the respective spray component from a first temperature taken at a first location along a respective receiving end of the hose to a second temperature taken at a second location along a respective delivery end of the hose that is at least 30° F. greater than the first temperature when flowed at a rate up to 12 lb/minute.

16. The system of claim 15, further comprising:
a first heater along the first suction line;
a second heater along the second suction line;
a first pump to pump the first spray component along the first fluid path;
a second pump to pump the second spray component along the second fluid path; and
an electrical motor to drive the first pump and the second pump, wherein the electric motor, first and second heaters, and first and second heated hoses are powerable at a same 220-240 VAC outlet.

17. The system of claim 16, wherein the second temperature is 40° F. to 60° F. greater than the first temperature, and wherein the first temperature is between 80° F. and 120° F. and the second temperature is between 135° F. and °160° F.

18. The system of claim 17, wherein the first container and second container are each between 5 gallon and 10 gallon.

19. The system of claim 16, wherein the second temperature is at least 160° F.

20. The system of claim 17, wherein the first and second locations of each heated hose are separated by approximately 200 linear feet of the hose having an inner diameter of approximately ½ inch through which approximately 400 linear feet of approximately ⅛ inch diameter heating element extends.

21. The system of claim 15, further comprising:
a first valve associated with the first recirculation manifold operable to selectively transition the first fluid path between a delivery mode and a recirculation mode, wherein in the delivery mode the first recirculation manifold fluidically couples the first suction line and the first delivery line, and wherein in the recirculation mode the first recirculation manifold fluidically couples the first suction line and the first return line; and
a second valve associated with the second recirculation manifold operable to selectively transition the second fluid path between a delivery mode and a recirculation mode, wherein in the delivery mode the second recirculation manifold fluidically couples the second suction line and the second delivery line, and wherein in the recirculation mode the second recirculation manifold fluidically couples the second suction line and the second return line.

22. The system of claim 17, wherein the first and second locations of each heated hose are separated along the hose by approximately 200 linear feet.

23. A spray component solution, the spray component solution being pumped along a fluid path of a spray proportioner unit between a container containing a supply of the spray component solution and a spray gun, the fluid path comprising
a suction line fluidically coupling the container to a recirculation manifold,
a delivery line including a heated hose, the heated hose comprising a heating element and extending between a receiving end and a delivery end, wherein the delivery line fluidically couples the recirculation manifold to the receiving end of the heated hose, and
a return line fluidically coupling the recirculation manifold to the container, and
wherein the heated hose is configured to heat the spray component from a first temperature, taken at a first location along the receiving end of the hose, to a second temperature, taken at a second location along the delivery end of the hose, that is at least 30° F. greater than the first temperature when flowed at a rate up to 12 lb/minute.

24. The spray component solution of claim 23, wherein the first and second locations are separated along the heated hose by approximately 200 linear feet.

25. The spray component solution of claim 23, wherein the second temperature is 40° F. to 60° F. greater than the first temperature, and wherein the first temperature is between 80° F. and 120° F. and the second temperature is between 135° F. and °160° F.

26. The spray component solution of claim 25, wherein the second temperature is at least 160° F.

27. The spray component solution of claim 23, wherein the fluid path further comprises:
a heater along the suction line;
a pump to pump the spray component along the fluid path; and
an electrical motor to drive the pump,
wherein the electric motor, heater, and heated hose are powered at a same 220-240 VAC power source.

28. The spray component solution of claim 23, wherein the container is sized between 5 gallons and 10 gallons.

29. The spray component solution of claim 28, wherein the first and second locations along the heated hose are separated by approximately 200 linear feet of the hose having an inner diameter of approximately ½ inch through which approximately 400 linear feet of approximately ⅛ inch diameter heating element extends.
